(19) United States
(12) Patent Application Publication
(10) Pub. No.: US 2024/0306760 A1
(43) Pub. Date: Sep. 19, 2024

(54) LIGHT-EMITTING HOLE SHOE

(71) Applicant: Fang HUANG, Hunan (CN)

(72) Inventor: Fang HUANG, Hunan (CN)

(21) Appl. No.: 18/522,245

(22) Filed: Nov. 29, 2023

(30) Foreign Application Priority Data
Mar. 17, 2023 (CN) 2023205410670

(51) Int. Cl. A43B 3/36; A43B 13/22; F21S 4/20

(52) U.S. Cl. CPC A43B 3/36; A43B 13/22; F21S 4/20; F21Y 2103/10; F21Y 2115/10

(57) ABSTRACT

A light-emitting hole shoe, having a sole and an upper; a rotatable fixing and binding belt is disposed on the upper; the upper is integrally formed by an upper part with vent holes, and a bottom part; a first cavity for accommodating a user's foot is formed between the upper part and the bottom part, and one end of the first cavity is provided with an opening from which the user's foot is inserted; a light-emitting assembly is disposed between the sole and the bottom part; the light-emitting assembly contains an LED light strip and a control box; the LED light strip is electrically connected with the control box; the sole is made of supercritical EVA foam.

### BACKGROUND OF THE INVENTION

The present utility model relates to the field of hole shoes, and in particular to a light-emitting hole shoe.

Hole shoe is a kind of “gardening shoe”, and can be considered as a sandal, but it is different from traditional sandal which exposes most part of a user's foot. On the contrary, hole shoe is characterized by a wide shoe width and a plurality of ventilation holes formed on the shoe upper, and hence protective to the user's foot while achieving ventilation effect. A hole shoe is convenient to wear and can be adorned by various ornaments, so hole shoe is popular. However, hole shoes in the market provides only a single function and lacks particularly lighting effects, so the hole shoes in the prior art are not appealing to younger children, and thus resulting in limitation in use and sale.

### BRIEF SUMMARY OF THE INVENTION

The present utility model provides a light-emitting hole shoe with lighting effects, so the hole shoe is more appealing to younger children.

The objective of the present utility model is attained as follows:

A light-emitting hole shoe, comprising a sole and an upper; the upper is integrally formed by an upper part with vent holes, and a bottom part; a first cavity configured to accommodate a user's foot is formed between the upper part and the bottom part, and one end of the first cavity is provided with an opening configured to allow the user's foot to insert into the light-emitting hole shoe; a light-emitting assembly is disposed between the sole and the bottom part; the light-emitting assembly comprises an LED light strip and a control box; the LED light strip is electrically connected with the control box; the sole is made of supercritical EVA foam.

Further, a bottom side of the sole is provided with an anti-slip layer.

Further, an upper side of the bottom part is provided with anti-slip patterns.

Further, the control box comprises a box body, and also comprises a main control circuit board, a battery and a vibration switch disposed in the box body.

Further, the LED light strip comprises a flexible circuit board and a plurality of LED lights; the LED lights are sequentially and evenly distributed on the flexible circuit board; the flexible circuit board is also provided with oval plastic sleeves that wrap the LED lights.

Further, the sole is provided with a second cavity that accommodates the light-emitting assembly.

Further, the second cavity comprises an annular groove and a limiting groove that contains the control box; the annular groove is connected with the limiting groove through a channel, the annular groove is disposed along a perimeter of the sole, and the LED light strip is disposed in the annular groove.

Further, the limiting groove is formed at a heel part of the sole.

According to the present utility model, a color-changing LED light strip is disposed between the sole and the bottom part, so that during use, the LED light strip can emit brilliant lighting effects, which greatly improves the appealing effect to children. Besides, since the sole and the upper are structured as different layers, they can be made of different materials, so as to enhance the performance of the hole shoe.

### BRIEF DESCRIPTION OF THE DRAWINGS

FIG. 1 is a top view of the light-emitting hole shoe according to the present utility model;

FIG. 2 is a right side view of the light-emitting hole shoe according to the present utility model;

FIG. 3 is a first cross-sectional view of the light-emitting hole shoe according to the present utility model;

FIG. 4 is a second cross-sectional view of the light-emitting hole shoe according to the present utility model;

FIG. 5 is a third cross-sectional view of the light-emitting hole shoe according to the present utility model; and

FIG. 6 is a schematic structural view of a light-emitting assembly of the present utility model.

Reference numerals in the figures: 1—sole, 110—anti-slip layer, 120—second cavity, 121—annular groove, 122—limiting groove, 123—channel, 2—upper, 210—upper part, 211—vent holes, 220—bottom part, 230—anti-slip pattern, 240—first cavity, 241—opening, 3—LED light strip, 301—flexible circuit board, 302—LED light, 303—oval plastic sleeve, 4—control box, 401—box body, 402—main control circuit board, 403—battery, 404—vibration switch, and 5—light-emitting assembly.

### DETAILED DESCRIPTION OF THE INVENTION

With reference to the accompanying drawings and specific embodiments, the present utility model is further described in detail below.

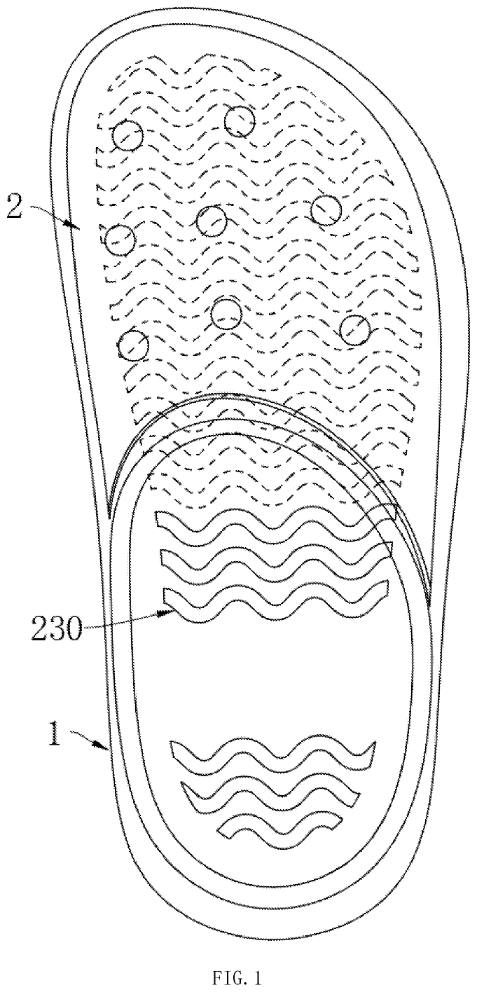

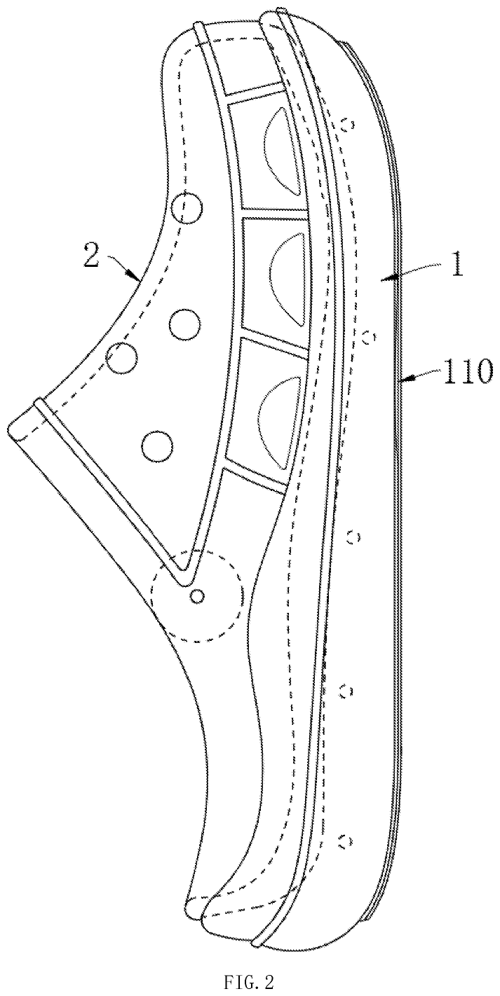

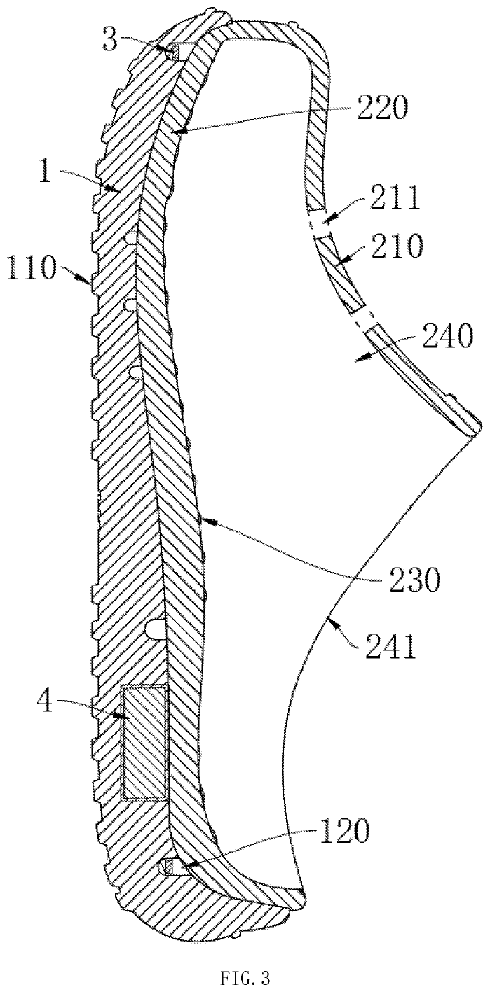

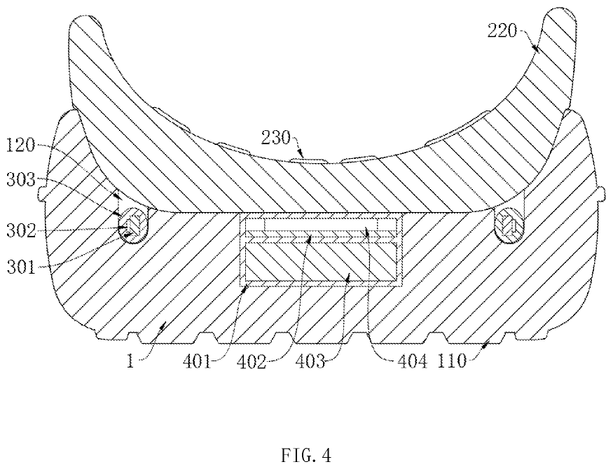

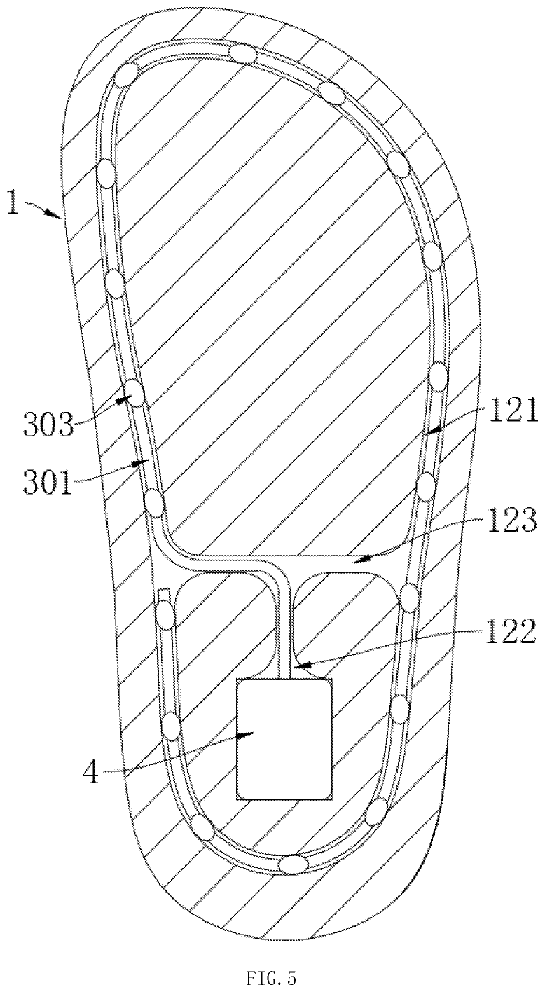

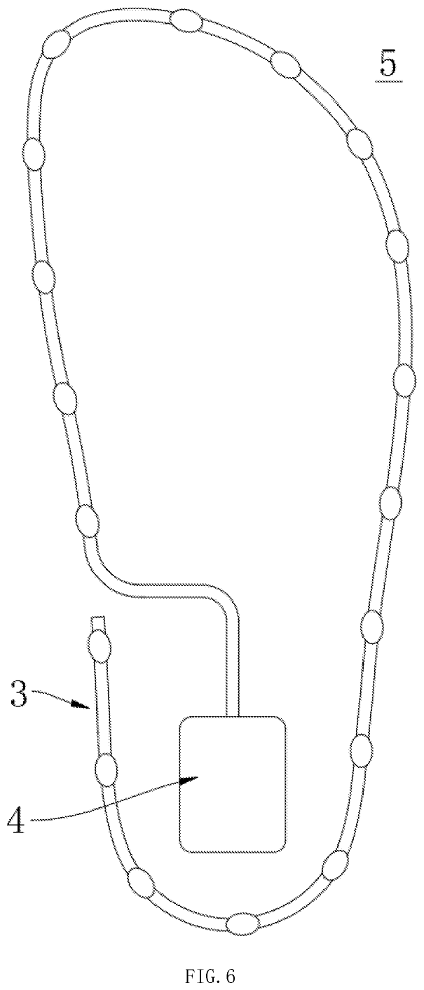

With reference to FIGS. 1-6, a light-emitting hole shoe according to the present embodiment comprises a sole 1 and an upper 2. The upper 2 is integrally formed by an upper part 210 with vent holes 211, and a bottom part 220; a first cavity 240 that accommodates a user's foot is formed between the upper part 210 and the bottom part 220, and one end of the first cavity 240 is provided with an opening 241 from which the user's foot is inserted. A light-emitting assembly 5 is disposed between the sole 1 and the bottom part 220; the light-emitting assembly 5 comprises an LED light strip 3 and a control box 4, the LED light strip 3 is electrically connected with the control box 4, and the sole 1 is made of supercritical EVA foam.

Furthermore, a bottom side of the sole 1 is provided with an anti-slip layer 110 integrally formed with the sole 1, and the anti-slip layer 110 is configured to increase frictional force with the ground to avoid slipping. Furthermore, an upper side of the bottom part 220 is provided with anti-slip patterns 230, and the anti-slip patterns 230 are configured to prevent the foot from slipping in the shoe and increase wearing stability.

Furthermore, the control box 4 comprises a box body 401, and also comprises a main control circuit board 402, a battery 403 and a vibration switch 404 disposed in the box body. In actual use, the lighting effects of the LED light strip 3 are actuated or switched through the vibration switch 404, wherein the vibration switch 404 can send different signals to the main control circuit board 402 according to a magnitude of the received vibration, so as to drive the LED light strip 3 to show different lighting effects. It should be noted that: the different lighting effects of the LED light strip 3 have to be realized by corresponding lighting effect programs pre-set by a computer on the main control circuit board 402, and this is a common technical means in the field.

The LED light strip 3 comprises a flexible circuit board 301 and a plurality of LED lights 302, the flexible circuit board 301 is electrically connected to the main control circuit board 402, the LED lights 302 are sequentially and evenly distributed on the flexible circuit board 301; the flexible circuit board 301 is also provided with oval plastic sleeves 303 for wrapping the LED lights 302. The oval plastic sleeves 303 can increase the waterproof property and the overall strength of the LED lights 302, so as to reduce the probability of breakage of the LED lights 302.

Furthermore, the sole 1 is provided with a second cavity 120 that accommodates the light-emitting assembly 5; the second cavity 120 comprises an annular groove 121 and a limiting groove 122 that contains the control box 4; the annular groove 121 is connected with the limiting groove 122 through a channel 123, the annular groove 121 is disposed along a perimeter of the sole 1, and the LED light strip 3 is disposed in the annular groove 121. A light-emitting direction of the LED lights 302 points outwardly from the hole shoe to improve the light utilization rate of the LED light strip 3.

Furthermore, the limiting groove 122 is formed at a heel part of the sole 1, so that the vibration switch 404 receives vibration feedback.

According to the present utility model, the color-changing LED light strip 3 is disposed between the sole 1 and the bottom part 220, so that during use, the LED light strip can emit brilliant lighting effects, which greatly improve the appealing effect to children. Besides, since the sole 1 and the upper 2 are structured as different layers, they can be made of different materials, so as to enhance the performance of the hole shoe. The sole 1 is preferably made of a wear-resistant and soft material, and the upper 2 is preferably made of an environment-friendly and comfortable material.

The above descriptions are merely the preferred embodiments of the present utility model and are not intended to make any form of limitation on the present utility model. Although the present utility model has been disclosed with the preferred embodiments as mentioned above, it is not intended to limit the present utility model. Any of those skilled in the art, without departing from the technical scope of the present utility model, may make some changes or modifications according to the disclosed technical content to form equivalent embodiments. As long as these simple amendments, equivalent changes, and modifications fall within the technical scope of the present utility model based on the disclosed techniques, they are all considered to be within the scope of the present utility model.

What is claimed is:

1. A light-emitting hole shoe, comprising a sole and an upper; wherein the upper is integrally formed by an upper part with vent holes, and a bottom part; a first cavity configured to accommodate a user's foot is formed between the upper part and the bottom part, and one end of the first cavity is provided with an opening configured to allow the user's foot to insert into the light-emitting hole shoe; a light-emitting assembly is disposed between the sole and the bottom part; the light-emitting assembly comprises an LED light strip and a control box; the LED light strip is electrically connected with the control box; the sole is made of supercritical EVA foam.

2. The light-emitting hole shoe of claim 1, wherein a bottom side of the sole is provided with an anti-slip layer.

3. The light-emitting hole shoe of claim 1, wherein an upper side of the bottom part is provided with anti-slip patterns.

4. The light-emitting hole shoe of claim 1, wherein the control box comprises a box body, and also comprises a main control circuit board, a battery and a vibration switch disposed in the box body.

5. The light-emitting hole shoe of claim 1, wherein the LED light strip comprises a flexible circuit board and a plurality of LED lights; the LED lights are sequentially and evenly distributed on the flexible circuit board; the flexible circuit board is also provided with oval plastic sleeves that wrap the LED lights.

6. The light-emitting hole shoe of claim 1, wherein the sole is provided with a second cavity that accommodates the light-emitting assembly.

7. The light-emitting hole shoe of claim 6, wherein the second cavity comprises an annular groove and a limiting groove that contains the control box; the annular groove is connected with the limiting groove through a channel, the annular groove is disposed along a perimeter of the sole, and the LED light strip is disposed in the annular groove.

8. The light-emitting hole shoe of claim 7, wherein the limiting groove is formed at a heel part of the sole.
